(19) United States
(12) Patent Application Publication
(10) Pub. No.: US 2007/0097957 A1
(43) Pub. Date: May 3, 2007

(54) Method for gracefully degrading packet data voice quality in a wireless communication network

(75) Inventors: Binshi Cao, Bridgewater, NJ (US); Xin Wang, Parsippany, NJ (US); Yang Yang, Parsippany, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/264,230

(22) Filed: Oct. 31, 2005

(51) Int. Cl. H04L 12/66

(52) U.S. Cl. 370/352

(57) ABSTRACT

A method for gracefully degrading packet data voice quality in a wireless network includes monitoring and evaluating data transfer conditions on the network. This may be done on a network-wide level, or for access terminals individually. For the evaluation, data transfer conditions are compared to criteria that indicate a relative quality level. Based on the evaluation, a variable number of the voice data packets addressed to the access terminals are eliminated prior to transmission over the airlink. If conditions are optimal, no data packets are eliminated. If not, one or more packets may be eliminated periodically (e.g., 1 data packet out of every five) until conditions change. The access terminals compensate for any eliminated packets. In this manner, packet data voice quality is gracefully degraded for temporarily reducing voice traffic on the network when conditions are poor, avoiding the need for dropped calls or the like.

### FIELD OF THE INVENTION

The present invention relates to communications and, more particularly, to wireless communications systems.

### BACKGROUND OF THE INVENTION

Various advances in commercial wireless and networking technologies have enabled the support of voice and high-speed data services to wireless-device end users, e.g., those using mobile phones, wireless personal digital assistants (PDA's), or the like. As third generation wireless packet data networks have evolved to support a wide range of multimedia and other high-speed data services, packet data voice services have become a viable alternative or replacement for traditional circuit switched voice communications.

In circuit switched systems, a physical or logical circuit (e.g., pathway) is established for each call, with the resources for the circuit being dedicated to the call during the entirety of its duration. In packet data networks, e.g., those using the Internet Protocol (“IP”) for data transmission generally and voice over IP (“VoIP”) for voice-data transmission, data is broken into a plurality of addressed data packets. For example, with VoIP, analog audio signals are captured, digitized, and broken into data packets. The data packets, both voice and non-voice, are then transmitted and routed over an IP-based communications network, where they are received and reassembled by the access terminal to which the data packets are addressed. Unlike circuit switched systems, however, the data packets may be sent at different times, out of order, and/or along different pathways. In this manner, data transmission resources are utilized in a more efficient and optimized manner.

The use of VoIP or the like allows voice services to be integrated with multimedia and other packet data services in a wireless communication network. This facilitates a diversity of applications, and may increase overall system performance. However, wireless networks present a particular challenge to packet voice traffic. In particular, the air interface in a wireless network (e.g., the radio link between one or more fixed base stations and various mobile or other wireless access terminals) is dynamic by nature, as is the system capacity and the performance associated with each voice user. Thus, there may be occasions where not enough bandwidth is available to accommodate every active user according to target levels of service quality. Additionally, even if bandwidth is available, there may be times when it is not possible to meet target or required service quality levels in transmitting voice data packets to a wireless access terminal, due to varying radio airlink conditions or the like. Because of this, wireless networks are typically provided with some sort of overload control. For example, one conventional overload control method used in circuit switched networks is to drop a certain number of existing voice calls to alleviate congestion. However, this clearly impacts service availability and user satisfaction. Additionally, in transferring non-voice data packets in a packet switched network, it may be acceptable to slow the overall data transfer rate as required based on the overall network load. With voice calls, however, this can only be done within the “real time” constraints of a conversation, since users typically expect there to be no noticeable network-based delays or interruptions in talking with others.

### SUMMARY OF THE INVENTION

An embodiment of the present invention relates to a method for communicating over a wireless network with a wireless unit/access terminal, which may include, for example, mobile phones, wireless PDA's, wireless devices with high-speed data transfer capabilities, such as those compliant with “3-G” or “4-G” standards, “WiFi”-equipped computer terminals, and the like. In carrying out the method, a radio network controller or other network component performs an evaluation of one or more data transfer conditions on the network. By “data transfer condition,” it is meant an indicator, measurement, or other factor relating to the performance of the network in terms of packet data transfer, singly (e.g., to an individual access terminal) and/or in the aggregate (e.g., to multiple access terminals). Based on the evaluation, the radio network controller eliminates a variable number (e.g., zero or more) of the voice data packets addressed to the access terminal, and transmits the remaining voice data packets.

For example, according to another embodiment, if the evaluation indicates that data transfer conditions on the network are optimal, it may be the case that no voice data packets are eliminated. However, if the evaluation indicates that the data transfer conditions are poor, one or more voice data packets may be eliminated on a periodic basis (e.g., one data packet out of every five is eliminated) until conditions improve.

In another embodiment, the access terminal is configured to compensate for any eliminated voice data packets, using a packet loss concealment algorithm or the like. In this manner, packet data voice quality is gracefully degraded for temporarily reducing voice packet data traffic on the network when conditions are poor, avoiding the need for severe or sudden quality of service reductions to any particular access terminal.

In another embodiment, a voice quality coefficient (“VQC”) is generated based on the radio network controller's evaluation of the data transfer conditions. By “voice quality coefficient,” it is meant an indicator of the quality level of the data transfer conditions. The VQC may be mapped to a set of voice data packet elimination rules that dictate which voice data packets to eliminate. The determination of which of the voice data packet elimination rules to use may also depend on the particular type of vocoder used to generate the voice data packets, as determined by checking packet format.

In another embodiment, the VQC is transmitted to the access terminal. The access terminal generates voice data packets for transmission over the reverse airlink, but eliminates a variable number of the voice data packets prior to transmission, based on the received VQC. For example, the access terminal may map the VQC to a set of voice data packet elimination rules that govern which voice data packets the access terminal may eliminate prior to transmitting the remaining, non-eliminated voice data packets. The determination of which of the voice data packet elimination rules to use may also depend on the particular type of vocoder used by the access terminal to generate the voice data packets.

### BRIEF DESCRIPTION OF THE DRAWINGS

The present invention will be better understood from reading the following description of non-limiting embodiments, with reference to the attached drawings, wherein below:

FIG. 1 is a schematic diagram of a wireless network configured for carrying out a method for gracefully degrading packet data voice quality according to an embodiment of the present invention;

FIGS. 2, 3, and 5 are flowcharts showing the steps of various embodiments of the method; and

FIGS. 4A and 4B are schematic diagrams showing transmissions of a voice quality coefficient (“VQC”).

### DETAILED DESCRIPTION

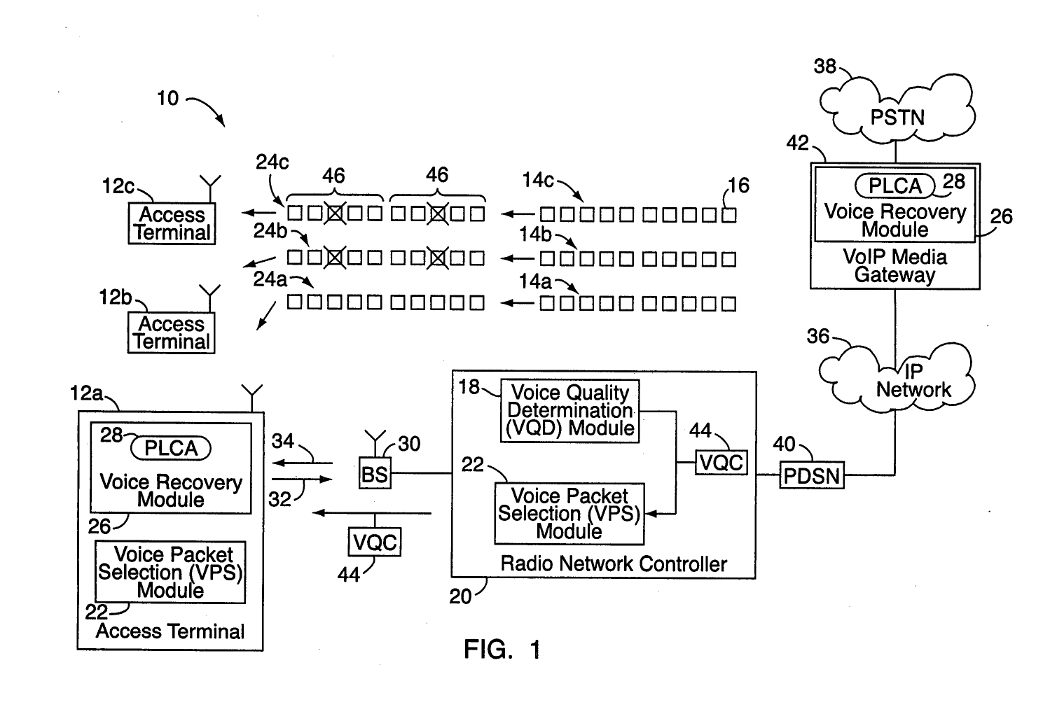

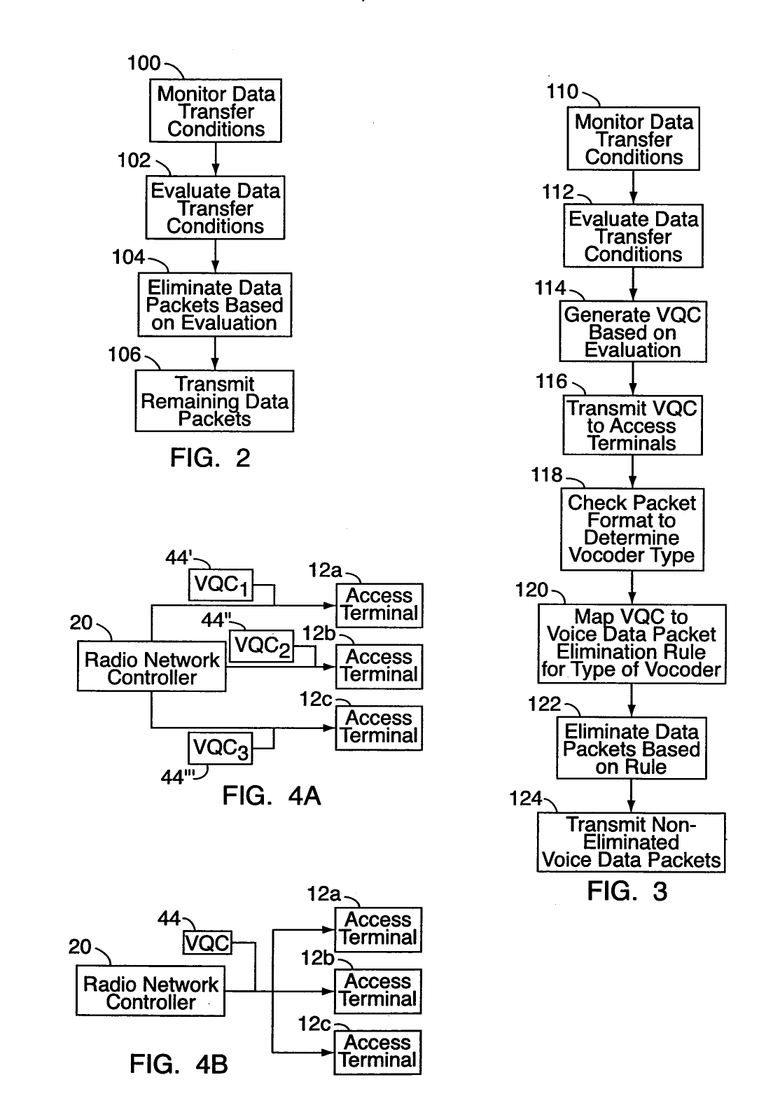

With reference to FIGS. 1-5, an embodiment of the present invention relates to a method for controllably reducing voice packet data traffic on a wireless communications network 10 by “gracefully” degrading packet data voice quality. The wireless network 10 is configured for transmitting voice data in packet form, using “VoIP” (Voice Over Internet Protocol) or the like. Thus, voice data for wireless access terminals/units 12a-12c in communication with the network 10 will typically comprise streams of data 14a-14c each including a plurality of voice data packets 16 respectively addressed to the access terminals 12a-12c. In carrying out the method, at Step 100 (see FIG. 2), data transfer conditions on the network are monitored on an ongoing basis by a voice quality determination (“VQD”) module 18 in place on a radio network controller portion 20 of the network 10 or elsewhere. At Step 102, the VQD module 18 evaluates or assesses the data transfer conditions according to one or more criteria. At Step 104, a voice packet selection (“VPS”) module 22 in place on the radio network controller 20 may eliminate one or more of the voice data packets 16 addressed to the access terminals 12a-12c. The number of voice packets eliminated by the VPS module 22 is based on the VQD module's evaluation of the data transfer conditions. At Step 106, the remaining voice data packets 24a-24c are transmitted to the access terminals in a standard manner.

As explained in more detail below, the data transfer conditions may relate to the voice or other data transmissions to an individual access terminal 12a, or to aggregate conditions on the network 10 such as overall voice traffic or other data load. For example, the VQD module 18 may monitor overall voice traffic load, and then determine whether or not voice data transmissions to the access terminals 12a-12c meet minimum service requirements. If there are too many active access terminals engaging in voice transmissions over the network to meet the minimum requirements, the VQD module 18 may eliminate, for example, one out of every five full rate data packets addressed to each access terminal 12a-12c. This reduces the overall voice data traffic load on the network, enabling the network to accommodate all the active users without significant service interruptions or the like. Each access terminal 12a-12c will typically be provided with a voice recovery module 26 having a packet loss concealment algorithm (“PLCA”) 28 for compensating for the eliminated voice data packets.

The method of the present invention may be implemented on any wireless network with a packet data voice service or the like. For example, the network 10 may be a CDMA-based 1x-EVDO communications network having a radio network controller 20 and one or more fixed base stations (“BS”) 30. (1x-EVDO is an implementation of the CDMA2000® “3-G” mobile telecommunications protocol/specification configured for the high-speed wireless transmission of both voice and non-voice data.) The base stations 30 are provided with various transceivers and antennae for radio communications with the wireless access terminals 12a-12c, while the radio network controller 20 directs data transfer to and from the base stations 30 for transmission to the access terminals. The access terminals 12a-12c may include, for example, mobile phones, wireless PDA's, wireless devices with high-speed data transfer capabilities, such as those compliant with “3-G” or “4-G” standards, “WiFi”-equipped computer terminals, and the like.

For conducting wireless communications between the base stations 30 and the access terminals 12a-12c, the network 10 may utilize a CDMA (code division multiple access) spread-spectrum multiplexing scheme. In CDMA-based networks, transmissions from access terminals to base stations are across a single frequency bandwidth known as the reverse link 32, e.g., a 1.25 MHz bandwidth centered at a first designated frequency. Generally, each access terminal 12a-12c is allocated the entire bandwidth all the time, with the signals from individual access terminals being differentiated from one another using an encoding scheme. Transmissions from base stations to access terminals are across a similar frequency bandwidth (e.g., 1.25 MHz centered at a second designated frequency) known as the forward link 32. The forward and reverse links may each comprise a number of traffic channels and signaling or control channels, the former primarily for carrying voice data, and the latter primarily for carrying the control, synchronization, and other signals required for implementing CDMA communications. The network 10 may be geographically divided into contiguous cells, each serviced by a base station, and/or into sectors, which are portions of a cell typically serviced by different antennae/receivers supported on a single base station.

The network 10 will typically include a core packet data network 36 for the long distance wire-line transmission of packet data, and/or for interconnecting various components or portions of the network 10. For example, the core packet data network 36 may be used to connect the radio network controller 20 to a network service or administration module, or to one or more external networks such as a public switched telephone network (“PSTN”) 38. As should be appreciated, the core packet data network 36 may be a dedicated network, a general-purpose network (such as the Internet), or a combination of the two. Typically, the radio network controller 20 will be connected to the packet data network 36 by way of a packet data serving node (“PDSN”) 40 or the like. Additionally, a VoIP media gateway access terminal 42 may be connected to the packet data network 36 for converting analog or non-VoIP transmissions from the PSTN 38 into VoIP, or vice versa. For high-speed data transmission across the packet data network 36 (e.g., for facilitating web browsing, real time file transfer, or downloading large data files), the network 10 may use the Internet Protocol, where data is broken into a plurality of addressed data packets. Additionally, VoIP may be used for voice-data transmission. (With VoIP, analog audio signals are captured, digitized, and broken into packets like non-voice data.) Both voice and non-voice data packets are transmitted and routed over the wireless network 10, where they are received and reassembled by the access terminals to which the data packets are addressed.

As noted above, the wireless network 10 is provided with the VQD module 18 for evaluating network data transfer conditions. The VQD module 18 may be implemented as a script or other computer program on the radio network controller 20 or elsewhere, or as a hardware or hardware/software module or the like, depending on the particular configuration of the wireless network 10. With reference to FIG. 3, at Step 110 the VQD module 18 monitors one or more data transfer conditions on the network 10. By “data transfer condition,” it is meant an indicator, measurement, or other factor relating to the performance of the network in terms of packet data transfer, singly (e.g., to an individual access terminal 12a) and/or in the aggregate (e.g., to multiple access terminals 12a-12c). Thus, the monitored data transfer conditions may include, for example, the overall or aggregate packet data load on the radio network controller 20 or elsewhere in the network 10 (voice and/or other data), the packet data load for an individual access terminal, data transfer rates, delay, and/or latency, user perceived throughput, the amount of data queued or buffered for transmission, or the like, either alone or in combination. In the wireless network 10, these conditions may vary based on the number of active access terminals in communication over the network 10, as well as on RF conditions across the reverse and/or forward links 32, 34. The data transfer conditions will typically be monitored on an ongoing basis, including periodic monitoring and/or monitoring at certain times of day, e.g., during times when the network 10 typically experiences high traffic loads.

At Step 112, the VQD module 18 evaluates the data transfer conditions. The evaluation may include comparing the data transfer conditions to one or more pre-established or dynamically generated performance criteria or reference values. For example, if the VQD module 18 is configured to monitor the voice packet data transmission latency for a wireless access terminal 12a individually, the VQD module 18 may compare the monitored transmission latency to a range of values that indicate a relative performance level. Thus, if the transmission latency for a given amount of voice packet data is 90 ms (milliseconds) for example, this may be compared to a scale indicating that: (i) a transmission latency of more than 80 ms indicates very poor performance (e.g., data is taking too long to get to the access terminal for a minimum quality of service level); (ii) a transmission latency of between 60 ms and 80 ms indicates poor performance; (iii) a transmission latency of between 40 ms and 60 ms indicates slow but acceptable performance; and (iv) a transmission latency of less than 40 ms indicates optimal performance. Other criteria may be used depending on which data transfer conditions are monitored, and on network configuration.

Once the VQD module 18 evaluates the network data transfer conditions, the VPS module 22 uses the evaluation as a basis for eliminating a variable number (e.g., zero or more) of voice data packets 16 addressed to one or more access terminals 12a-12c. For this purpose, information relating to the VQD module's evaluation may be provided in a “shorthand” manner as a voice quality coefficient (“VQC”) 44, as at Step 114 in FIG. 3. The VQC 44 may be a numerical or other value that “summarizes” the data transfer conditions as evaluated by the VQD module, in terms of a relative performance level or the like. Thus, for example, in the case given above, the VQD module 18 may generate a “0” VQC value for latencies of less than 40 ms, a VQC value of “1” for latencies between 40 ms and 60 ms, a VQC value of “2” for latencies between 60 ms and 80 ms, and a VQC value of “3” for latencies above 80 ms. As discussed further below, as at Step 116 in FIG. 3, the VQC 44 may be transmitted to the access terminals 12a-12c for their use in eliminating voice data packets prior to transmission over the reverse link 32. The VQC 44 may be transmitted in various manners, including as a separate transmission, as part of standard system control messages, as part of a broadcast overhead message, or the like. For this purpose, the VQC 44 is appropriately encoded for transmission and/or provided with headers and footers to identify the VQC 44 for the access terminals 12a-12c.

FIG. 1 shows the VPS module 22 in place on the radio network controller 20. In addition, the access terminals 12a-12c may also be provided with a VPS module 22. In both cases, the VPS module 22 is configured to eliminate a variable number of the voice data packets meant for transmission over the network 10, based on the VQD module's evaluation of the network data transfer condition. In other words, based on network conditions as indicated by the VQC 44, the VPS module 22 transmits (or allows to be transmitted) only a selected number of voice data packets, for purposes of controllably reducing voice data traffic during times when data transfer conditions on the network are less than optimal, and without severe or sudden service cuts to any particular access terminal. In addition to the data transfer conditions, the determination of which packets to eliminate may also depend on the vocoder used for generating the voice data in the data packet. (A “vocoder” is a device for converting speech to data.) This can be determined by checking the packet data format (e.g., configuration and/or size), as at Step 118. Thus, at Step 120 in FIG. 3, the VPS module 22 maps the VQC 44 into one of several voice packet selection rules (discussed further below) that yield a desired voice quality level for a particular vocoder type. Then, at Step 122, according to the rule mapped from the VQC 44, the VPS module 22 eliminates a variable number of the voice data packets 16 meant for transmission to one or more access terminals 12a-12c. At Step 124, the remaining, non-eliminated data packets are transmitted to the access terminals 12a-12c in a standard manner.

The degree or extent of data packet elimination will typically be proportional to the data transfer conditions. In other words, the worse the data conditions, the greater the number of voice data packets potentially selectively eliminated. This may include eliminating no data packets, thereby allowing all data packets to be transmitted, if data transfer conditions are optimal. Also, from a stream 14a of data packets addressed to an access terminal 12a, it will typically be that case that the variable number of data packets is eliminated: (i) from every successive sub-group 46 of data packets, e.g., one out of every five data packets is eliminated; and (ii) on a periodic and ongoing basis until data transfer conditions change.

The voice recovery module 26 (in conjunction with the PLCA 28) is in place on the access terminals 12a-12c, 42 for recovering analog voice signals from voice packet data. The voice recovery module 26 is also configured to compensate for the voice data packets eliminated by the VPS module 22. The voice recovery module 26 may be a separate software and/or hardware module, or it may be provided as an existing part of the access terminal's vocoder circuitry/software for converting voice packet data into analog signals for playback over an access terminal earpiece or loudspeaker. In particular, packet voice services in a wireless network are expected to normally suffer from a large variation of packet delay/jitter and drop performance, due to changing system loads and RF conditions. Accordingly, the access terminals 12a-12c, 42 may already have a voice recovery module 26 to compensate for dynamic levels of voice packet reception performance, including voice packet latency/jitter absorption and erasure concealment functions. This existing functionality can be utilized according to the present invention for outputting controllably degraded voice quality when encountering deliberately created isolated or intermittent voice packet erasures, and without explicit notification of the packet elimination rules.

Current wireless vocoder or vocoder codecs such as “EVRC” (Enhanced Variable Rate Codec) and “4GV™” (Fourth-Generation Vocoder™) work on short time frames. In the case of EVRC, speech data is typically processed at a sampling frequency of 8 kHz and in 20 ms frames, with each frame therefore including 20 ms worth of encoded audio data. (The data packets 16 may each contain one or more frames, depending on system configuration.) Due to the high temporal correlation of voice samples with 8 kHz sampling rates, these vocoders are able to conceal isolated or intermittent voice data packet erasures among correctly received voice data packets, minimizing the impact on voice quality. Therefore, by selecting the voice data packets to be eliminated (and, correspondingly, the voice data packets to be transmitted) as set forth herein, the VPS module 22 is able to offer different voice qualities with different data rates from the same vocoder coded packet data stream, dynamic in time transparent to the voice recovery module 26.

The VPS module 22, like the VQD module 18, may be implemented as a script or other computer program on the radio network controller 20 or elsewhere, or as a hardware or hardware/software module or the like. As such, the functionality provided by the VPS module 22 and VQD module 18 may be integrated into a single software module or the like. However, for implementation on the access terminals 12a-12c, the VPS module 22 will typically be provided separately without the functionality of the VQD module 18.

The following table shows an example of how the data transfer conditions and/or VQC might be mapped to a set of voice packet elimination rules for EVRC and 4GV™ vocoders:

| Data Transfer | | Voice Packet Elimination Rule | |
|---|---|---|---|
| Conditions | VQC | EVRC | 4GV ™ |
| Optimal/Good | 0 (Regular) | No voice data | No voice data packets |
| | | packets | eliminated. |
| | | eliminated. | |
| Fair | 1 (Slight | One of every 5 | One of every 3¼-rate |
| | Degradation | full rate | (except for the first |
| | in Voice | packets is | one following a full- |
| | Quality) | eliminated, | rate frame) packets is |
| | | except for the | eliminated, except for |
| | | first 2 | the first 2 packets |
| | | packets arrived | arrived after a long |
| | | after a | silence. |
| | | long silence. | |
| Poor | 2 (Moderate | One of every 3 | All ¼-rate |
| | Degradation | full rate | (except for the first |
| | in Voice | packets is | one following a full- |
| | Quality) | eliminated, | rate frame) packets |
| | | except for the | are eliminated, except |
| | | first 2 | for the first 2 packets |
| | | packets arrived | arrived after a long |
| | | after a | silence. |
| | | long silence. | |
| Very Poor | 3 (Significant | One of every 2 | All ¼-rate |
| | Degradation | full rate | and ½ rate |
| | in Voice | packets is | (except for the first |
| | Quality) | eliminated, | one following a full- |
| | | except for the | rate frame) packets |
| | | first 2 | are eliminated, except |
| | | packets arrived | for the first 2 packets |
| | | after a | arrived after a long |
| | | long silence. | silence. |

As indicated in the table, applying the rule that corresponds to a VQC for “fair” network data transfer conditions, for example, will typically result in the elimination of only so many voice data packets as results in a slight degradation of voice quality for the particular vocoder type. Thus, the particular rules for each vocoder type (and/or voice recovery module 26 and PLCA 28) may be determined in the first instance based on system/network configuration and field-testing, including possible qualitative determinations of what constitutes various levels of voice quality degradation.

Voice data packets 16 have a limited number of distinctive packet formats for each vocoder type. As at Step 118 in FIG. 3, the VPS module 22 is able to recognize different types of voice packets from packet format. From this information, the VPS module 28 determines the particular type of vocoder that was used to generate the voice packet data 16, for use in choosing the particular voice packet elimination rule to apply.

As noted above, the voice packet elimination rules may be applied on an individual basis for each access terminal 12a-12c. Thus, the VQD module 18 may monitor data transfer conditions as relating to each access terminal individually, and eliminate voice data packets 16 addressed to the access terminals accordingly. For example, if a particular access terminal is experiencing poor RF conditions over the forward link 34, with correspondingly long data transfer latencies as detected by the VQD module 18, then the VPS module 22 may eliminate some of the voice data packets 16 meant for transmission to the access terminal according to a packet elimination rule. Thus, the network 10 is able to relieve wireless congestion by reducing the voice traffic amount to or from access terminals experiencing the worst performance and/or that are using the greatest amount of system resources. However, instead of severe reductions in service quality including possible dropped calls, the voice quality of the impacted calls is degraded gracefully along with the traffic reduction. Also, traffic reduction and voice quality degradation are performed on a dynamically on-demand basis, meaning that they are fully revertible when data transfer conditions on the network improve.

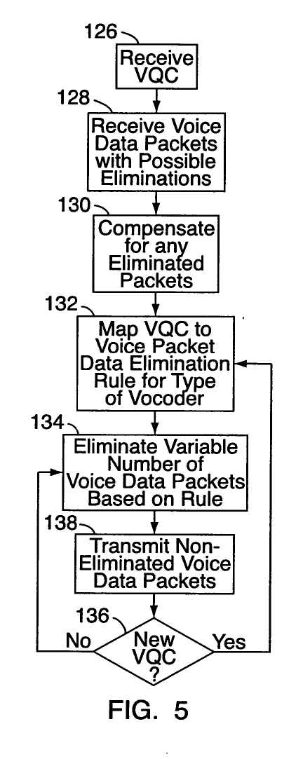

The VQD module 18 may monitor and evaluate data transfer conditions with respect to each access terminal individually, at an aggregate or network-wide level, or both. Correspondingly, the VQD module 18 may generate and transmit an individual VQC 44′, 44″, 44′″ for each access terminal 12a-12c (see FIG. 4A), or it may generate one VQC 44 that is transmitted to each access terminal 12a-12c (see FIG. 4B). For the former, the respective VQC's may be based on the data transfer conditions to each access terminal individually, on the aggregate conditions, or both. For the latter, the VQC will typically be based on the aggregate conditions alone. Thus, for example, if the data transfer conditions to a first access terminal are within good or optimal parameters, but the overall conditions on the network are poor, it may be the case that the VQD module 18 generates a VQC 44 that results in a slight degradation in voice quality to the first access terminal, to reduce overall network traffic or load.

In the network 10, the radio network controller 20 may already monitor data transfer conditions on an ongoing basis for one or more purposes, such as for monitoring quality of service levels. For example, the radio network controller 20 may have an “overload” function whereby the quality level of one or more active calls is severely reduced if system congestion/conditions warrant. If this is the case, the VQD module 18 may utilize or otherwise take advantage of existing monitoring functionality in carrying out its operations according to the above.

A “start to finish” example of one embodiment of the method for gracefully degrading voice quality of the present invention will now be described with reference to FIGS. 1, 3, and 5. In ongoing operations for voice packet data calls (e.g., VoIP) to the access terminals 12a-12c, various data streams 14a-14c arrive at the radio network controller 20. (It is assumed that the radio network controller 20 and/or base station 30 have already performed the signaling functions necessary to establish an active connection with the access terminals 12a-12c.) Each data stream 14a-14c contains a plurality of voice data packets 16, each respectively addressed to the access terminals 12a-12c. The data streams arrive from elsewhere in the network 10. For example, in the case of a wire-line phone user placing a voice call to a wireless access terminal user, analog or digital voice signals are transmitted over the PSTN 38, where they are converted by the VoIP media gateway 42 into VoIP data packets 16 addressed to the access terminal in question. The data packets 16 are then transmitted over the IP network 36, and switched to the radio network controller 20 through the PDSN 40. At Step 110, the VQD module 18 monitors the data transfer conditions with respect to each access terminal 12a-12c, and then performs an evaluation of the conditions at Step 112. At Steps 114 and 116, the VQD module 18 generates and transmits a VQC 44 for each access terminal 12a-12c. At Step 126 in FIG. 5, the access terminals 12a-12c receive the VQC's 44.

At Step 120, the VPS module 22 in the radio network controller 20 maps the VQC 44 for each access terminal into a voice data packet elimination rule, which may also take into account the vocoder type used to form the data packets (or audio data therein) addressed to the access terminal, as determined by checking the packet format in Step 118. At Step 122, the VPS module 22 may eliminate some of the data packets meant for transmission to the access terminals 12a-12c, based on the voice data packet elimination rules. If data transfer conditions are optimal, none of the data packets will be eliminated. At Step 124, the remaining, non-eliminated data packets are transmitted to the access terminals as data streams 24a-24c. The elimination step may be carried out in a “positive” or “negative” manner, the former referring to selecting data packets for elimination and transmitting the remaining, non-eliminated packets, the latter referring to selecting data packets for transmission and not transmitting the remaining, eliminated data packets. At Step 128 in FIG. 5, the access terminals receive the transmitted data streams 24a-24c. At Step 130, the voice recovery module 26 and/or PLCA 28 in each access terminal compensates for any eliminated data packets.

For transmissions across the reverse link 32, at Step 132, the VPS module 22 in an access terminal 12a maps the VQC 44 as received in Step 126 into a voice data packet elimination rule, which may also take into account the vocoder type used to form the voice data packets. Based on the elimination rule, at Step 134, the VPS module 22 eliminates a variable number (e.g., zero or more) of the data packets meant for transmission over the reverse link 32, possibly on an ongoing and periodic basis until a different VQC 44 is received, as determined at Step 136. At Step 138, the remaining voice data packets are transmitted. Once the transmitted voice data packets reach their destination, or an intermediate location such as a VoIP media gateway 42, the voice recovery module 26 and/or PLCA 28 in place on the media gateway 42 or elsewhere compensates for any eliminated data packets in the manner described above (e.g., by way of the existing PLCA's in place on EVRC and 4GV™ vocoders).

Since certain changes may be made in the above-described method for gracefully degrading packet data voice quality in a wireless communications network, without departing from the spirit and scope of the invention herein involved, it is intended that all of the subject matter of the above description or shown in the accompanying drawings shall be interpreted merely as examples illustrating the inventive concept herein and shall not be construed al limiting the invention.

What is claimed is:

1. A method of communicating over a network with at least one wireless unit, the method comprising the steps of:
eliminating a variable number of a plurality of voice data packets addressed to the wireless unit based at least in part on an evaluation of at least one network data transfer condition; and
transmitting non-eliminated voice data packets to the wireless unit.

2. The method of claim 1 further comprising the step of:
generating at least one voice quality coefficient based on the evaluation, wherein the variable number is based at least in part on the at least one voice quality coefficient.

3. The method of claim 2 further comprising the step of:
transmitting the at least one voice quality coefficient to the wireless unit.

4. The method of claim 1 further comprising the step of:
determining a type of vocoder used to generate the plurality of voice data packets addressed to the wireless unit, wherein the variable number is based on the vocoder type in addition to the evaluation.

5. The method of claim 1 wherein:
the plurality of voice data packets addressed to the wireless unit comprises a plurality of successive subgroups each of which includes a designated number of voice data packets of said plurality; and
the method further comprises eliminating voice data packets from each of said subgroups according to the variable number that has been determined.

6. The method of claim 1 further comprising the step of:
evaluating the at least one network data transfer condition.

7. The method of claim 6 wherein the step of evaluating the at least one network data transfer condition comprises:
determining a current performance level of voice data transmissions to one or more wireless units in communication with the network; and
comparing the current performance level to a reference value.

8. The method of claim 7 wherein the current performance level is at least one of a data transfer rate, a transmission latency rate, and a data load.

9. The method of claim 6 wherein the step of evaluating the at least one network data transfer condition comprises:
determining a current aggregate load of voice data transmissions to a plurality of wireless units in communication with the network; and
comparing the current aggregate load to a reference value.

10. The method of claim 6 further comprising the steps of:
periodically re-evaluating the at least one network data transfer condition; and
periodically re-determining the variable number of voice data packets to be eliminated in response to said periodic re-evaluation.

11. A method of communicating over a network with a plurality of wireless units, the method comprising the steps of:
transmitting a plurality of voice data packets to each wireless unit; and
determining a variable number of the plurality of voice data packets to be eliminated for each wireless unit prior to transmission, wherein the variable number is based at least in part on an assessment of at least one data transfer condition of the network.

12. The method of claim 11 further comprising the step of:
generating at least one voice quality coefficient based on the assessment of the at least one data transfer condition, wherein the variable number is based on the at least one voice quality coefficient.

13. The method of claim 12 further comprising the step of:
transmitting the at least one voice quality coefficient to the wireless units.

14. The method of claim 11 further comprising the step of:
determining a type of vocoder used to generate the plurality of voice data packets for each wireless unit, wherein the variable number is based on the type of vocoder in addition to the assessment of the at least one data transfer condition.

15. The method of claim 11 wherein:
the plurality of voice data packets for each wireless unit comprises a plurality of successive subgroups each of which includes a designated number of voice data packets of said plurality; and
the method further comprises eliminating voice data packets from each of said subgroups according to the variable number that has been determined.

16. The method of claim 11 wherein the at least one data transfer condition is assessed with respect to each wireless unit individually.

17. A method of transmitting voice data over a wireless network, the method comprising the steps of:
generating a plurality of voice data packets for transmission over the network; and
eliminating a variable number of voice data packets of said plurality prior to transmission, wherein the variable number is based at least in part on a received voice quality coefficient relating to data transfer conditions on the network.

18. The method of claim 17 wherein:
the plurality of voice data packets comprises a plurality of successive subgroups each of which includes a designated number of voice data packets of said plurality; and
the method further comprises eliminating voice data packets from each of said subgroups according to the variable number.

19. The method of claim 17 wherein the variable number of voice data packets of the plurality that are to be eliminated is further based on a type of vocoder used to generate the voice data packets.

20. The method of claim 19 wherein:
the plurality of voice data packets comprises a plurality of successive subgroups each of which includes a designated number of voice data packets of said plurality; and
the method further comprises eliminating voice data packets from each of said subgroups according to the variable number.
